(19) United States
(12) Patent Application Publication
(10) Pub. No.: US 2014/0122083 A1
(43) Pub. Date: May 1, 2014

(54) CHATBOT SYSTEM AND METHOD WITH CONTEXTUAL INPUT AND OUTPUT MESSAGES

(71) Applicant: Duan Xiaojiang, Chaoyang District (CN)

(72) Inventor: Duan Xiaojiang, Chaoyang District (CN)

(21) Appl. No.: 13/661,040

(22) Filed: Oct. 26, 2012

(51) Int. Cl. G10L 11/00

(52) U.S. Cl. 704/270.1; 704/E11.001

(57) ABSTRACT

A chatbot system and method with contextual input/output messages. A chatbot includes a processor, an interactive dialog interface and a knowledge database. The system uses a script file to display input and output messages in a tree format. An initial input or output message is stored. An identifier is assigned to the initial input or output message that is then used as context for the subsequent input/output messages by associating and storing the identifier with the subsequent input/output messages. The relationship between the first input or output message and subsequent input/output messages define a parent-child relationship that is displayable via the script file.

A computer program listing appendix is provided via EFS with this application. The information is hereby incorporated by reference as if set forth in full in this application for all purposes. A portion of the disclosure recited in this application contains material which is subject to copyright protection. Specifically, the computer program listing appendix and possibly other portions of the application may recite or contain source code, data or other functional text. The copyright owner has no objection to the facsimile reproduction of the functional text; otherwise all copyright rights are reserved.

### BACKGROUND OF THE INVENTION

The present invention relates generally to chatbot systems and methods and more specifically to chatbot systems and methods for enhancing user input communication.

Chatbot computer programs are designed to simulate intelligent conversation with one or more human users via auditory or textual methods. Chatbots are often integrated into interactive dialogs for various practical purposes such as personalized service or information acquisition.

An interactive dialog between a user and the chatbot is referred to as a chat session. The answers that the user receives from the chatbot are often preprogrammed into the chatbot. For example, a typical chat session between a user and chatbot may be:
User: Are you a female bot?
Chatbot: Yes. Are you a girl?
User: Yes.
Chatbot: How do you feel being a girl?

To enable the chatbot to chat as above, administrators of conventional systems typically use two input/output messages to effectuate the chat:
Entry 1 User: Are you a female bot?
   Chatbot: Yes. Are you a girl?
Entry 2 User: Yes
   Context: Are you a girl?
   Chatbot: How do you feel being a girl?

Such entries are often referred as chatbot content. Note that the message “Are you a girl” appears twice in the entries, as two separate entries, once in Entry 1 for the chatbot, and once in Entry 2 for the context.

Administrators often modify input/output messages to keep their content current. As an example, an administrator might wish to modify the content to change all entries of the word “girl” to “female.” The administrator begins by editing Entry 1 to make the change. Following that, as with many human tasks, the administrator may forget to also make the same change in Entry 2. As a result, the following entries result:
Entry 1 User: Are you a female bot?
   Chatbot: Yes. Are you a female?
Entry 2 User: Yes
   Context: Are you a girl?
   Bot: How do you feel being a girl?

As a result, a conversation based on this partially updated entry is:
User: Are you a female bot?
Chatbot: Yes. Are you a female?
User: Yes.
Chatbot: [No Response]

As can be seen, the chatbot has no response (or has an incoherent response) when the user replies “Yes” to the Chatbot question “Are you a female?” because the context in Entry 2 is “Are you a girl?” and not “Are you a female?”.

It is within the aforementioned context that a need for the present invention has arisen. Thus, there is a need to address one or more of the foregoing disadvantages of conventional systems and methods, and the present invention meets this need.

### BRIEF SUMMARY OF THE INVENTION

Various aspects of a chatbot system and method with contextual input/output messages can be found in exemplary embodiments of the present invention.

In a first embodiment, a chatbot includes a processor, an interactive dialog interface, a knowledge database and one or more scripts. The script can represent contextual input/output messages and can be used to create, add to or modify knowledge entries in the knowledge database.

Upon receiving a first input, the chatbot assigns an identifier to that first input message after which the first input message is stored as a root entry. A root entry might be a parent or first entry in a tree format structure. Subsequent input/output messages that use the first input or output message as context are also assigned the same identifier as their context and stored as child entries of the first input or output message. Each subsequent input/output message also has its own unique identifier to identify each message and to reference other messages that use the message as context. In one embodiment, the script of the present invention displays the entirety of input and output messages and their context in a tree format so that users can easily view the relationship between input and output messages and their context. With the script, users can also edit and manipulate input/output messages and corresponding context as proves necessary.

In this manner, and unlike conventional systems, separate multiple entries are not needed to effectuate a chat since the input/output messages are based on the script identifier and unique identifiers assigned to each message, thus establishing a direct relationship between an entry and its context. Context information of an entry is not stored as input/output text but rather as the reference to other entries.

Unlike traditional chatbot systems, an administrator can update one entry without having to update multiple corresponding entries, thus ensuring that the chatbot always generates a response even where an administrator modifies one entry but not the other.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 illustrates a chatbot communication system according to an exemplary embodiment of the present invention.

FIG. 2 illustrates a chatbot dialog interface of the chatbot system of FIG. 1 in accordance with an exemplary embodiment of the present invention.

FIG. 3 illustrates a chat log according to an exemplary embodiment of the present invention.

FIG. 4 illustrates a scripts interface according to an exemplary embodiment of the present invention.

FIG. 5A illustrates a script interface “Are all plans free?” in accordance with an exemplary embodiment of the present invention.

FIG. 5B illustrates a script interface “Edit Script Are all plans free?” according to an embodiment of the present invention.

FIG. 5C illustrates a script interface “EDIT BOT REPLY: THERE ARE SEVERAL AVAILABLE PLANS. ONE IS FREE” according to an exemplary embodiment of the present invention.

FIG. 6A illustrates a script interface “CREATE USER REPLY” according to an exemplary embodiment of the present invention.

FIG. 6B illustrates a script interface “Are all plans free?” according to an exemplary embodiment of the present invention.

FIG. 7A illustrates a script interface “CREATE BOT REPLY” according to an exemplary embodiment of the present invention.

FIG. 7B illustrates a script interface “Are all plans free?” according to an exemplary embodiment of the present invention.

FIG. 8 illustrates a flow chart of a method for representing contextual entries according to an exemplary embodiment of the present invention.

FIG. 9A shows a typical computer 10 such as would be operated by a user.

FIG. 9B shows subsystems of the computer of FIG. 9A.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

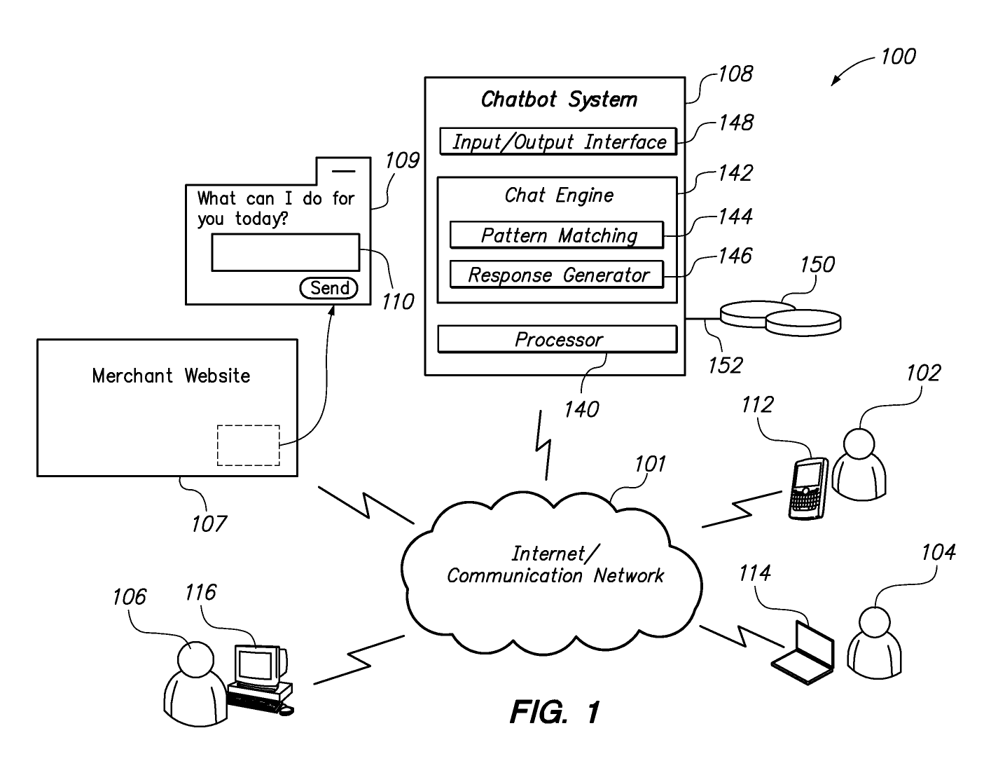

FIG. 1 illustrates chatbot communication system 100 according to an exemplary embodiment of the present invention.

In FIG. 1, chatbot communication system 100 comprises user 102 communicably coupled to chatbot system 108 via Internet 101. User 102 represents a customer visiting a website over Internet 101, and commencing a chat session with chatbot system 108.

Internet 101 represents any distributed network (wired, wireless or otherwise) for data transmission and receipt between/among two or more points. In some embodiments, chatbot system 108 includes a graphical image, including, without limitation, an avatar, a talking head, a text-to-speech engine, etc. Although not shown, chatbot system 108 might be installed on a stand-alone computer without need for a computer network.

As shown in FIG. 1, user 102 utilizes mobile device 112 to communicate with chatbot system 108. Mobile device 112 is a portable communication device such as a smart phone and the like. In one embodiment, the communication with chatbot system 108 can occur when user 102 is visiting one or more websites such as merchant website 107 that has chatbot dialog interface 116 of chatbot system 108 preinstalled on the website as further discussed below. User 102 essentially uses a browser (not shown) and chatbot dialog interface 116 to interact with chatbot system 108.

In FIG. 1, user 104 represents an additional customer. Many customers can concurrently communicate with chatbot system 108. Here, user 104 utilizes laptop computing device 114 for communicating with chatbot system 108 in a manner akin to user 102. For example, user 104 visiting merchant website 107 can also communicate with chatbot system 108 via chatbot dialog interface 116.

In FIG. 1, merchant 106 represents a merchant that operates merchant website 107. Merchant 106 installs chatbot dialog interface 116 of chatbot system 108 on its merchant website 107. Chatbot dialog interface 116 is a client extension of chatbot system 108. Thus, users can communicate with chatbot system 108 via chatbot dialog interface 116. Consequently, users visiting merchant website 107 can learn about products and/or services offered by merchant 106 by communicating with chatbot system 108 via chatbot dialog interface 116.

Here, merchant 106 provides initial training for chatbot system 108 by using a browser (not shown) on desktop computing device 115. Specifically, merchant 106 uses the browser to access and display chatbot dialog interface 116 to communicate with chatbot system 108. In essence, merchant 106 provides the message and theme for chatbot system 108 while users 102, 104 are the corresponding consumers.

Merchant 106 can train chatbot system 108 by entering input messages into dialog box 110 of chatbot dialog interface 116. Chatbot system 108 responds to an input message by displaying an output message via output display 109 above dialog box 110. As shown, an output message “What can I do for you today?” is displayed by output display 109. Note that this is a special output message, called an initial or opening message. Its corresponding “input message” is the user's action of browsing to a web page.

Chatbot messages are generated by chatbot system 108 by querying the input message from users in a knowledge base according to a certain set of rules. Merchant 106 trains chatbot system 108 to provide modified messages for a chat session by replacing chatbot system 108's initial chatbot messages with user-generated messages.

Chatbot system 108 includes a graphical image representing chatbot dialog interface 116, the graphical image including, without limitation, an avatar, a talking head, a text-to-speech engine, etc. In some embodiments, users 102, 104, 106 enter input messages to chatbot system 108 with a keyboard, mouse, and a visual recognition device.

The back and forth interaction between chatbot system 108 and users 102, 104 and 106 via chatbot dialog interface 116 allows knowledge database 150 to store and process myriad combinations of user-generated messages as context for additional future chatbot messages.

In FIG. 1, chatbot system 108 includes input/output interface 148 for entering and displaying messages to and from users 102, 104, 106. Chatbot system 108 also includes chat engine 142 that receives an input message from dialog box 110 and processes the input message by pairing or associating the input message with an appropriate chatbot message. Note that, conveniently, one or more components of chatbot system 108 may be conveniently referred to as chatbot system 108.

Chat engine 142 utilizes pattern matching engine 144 to recognize appropriate responses for input messages. In one embodiment, pattern matching engine 144 employs AIML (Artificial Intelligence Markup Language), which is an XML dialect. Note that AIML implementation is used in one embodiment but other implementations are used as well. Here, AIML comprises several elements. A first is category, which is a fundamental unit of knowledge. A category includes two or more elements (e.g. pattern and template).

<category>

<pattern>WHAT IS YOUR NAME</pattern>
<template>My name is Eddy.</template>

</category>

When this category is loaded, a chatbot receiving an input “What is your name” can respond with “My name is Eddy.” Here, a pattern is a string of characters that can match one or more user inputs. A pattern such as “What is your name” matches only one input, whether upper or lower case. However, patterns can also contain wildcards; thus, “what is your *” can match many inputs such as “what is your objective,” what is your address,” etc.

A template provides the response for a pattern. An example of a template is—My name is Eddy. A template can also use variables. A template may be as simple as some literal text, like “My name is <chatbot name=“name”/>,” which substitutes the chatbot's name into the sentence, or “You said you are <get name=“userage”/> years of age,” in which the user's age is replaced in the sentence.

Text formatting, conditional response (if then/else), and random responses are elements of templates. Templates can also use the srai element to redirect to other pattern.

<category>

<pattern>What is your name</pattern>

<template>My name is <bot name=“name”></template>

</category>
<category>

<pattern>WHAT IS YOUR GIVEN NAME</pattern>

<template>

<srai>What is your name</srai>

</template>

</category>

In the first category, the input “What is your name” receives the chatbot's name as a response. In the second category, the input “WHAT IS YOUR GIVEN NAME” is redirected to the category that matches the input “What is your name.” In essence, the two phrases are equivalent. Templates may include other content types that are processed by the chatbot user interface. As an example, a template may employ HTML (Hyper-Text Markup Language) tags for formatting. Clients not supporting HTML typically ignore the tag.

Those skilled in the art will recognize that other techniques that can either substitute or supplement pattern matching engine 144 can be employed. After pattern matching engine 144 recognizes appropriate responses for input messages, pattern matching engine 144 then passes the chatbot message to response generator 146, which generates an appropriate response.

In FIG. 1, in one embodiment, knowledge database 150 may receive and store input messages 210 and user-generated messages including the context for such messages, the messages being received via chatbot dialog interfaces 116 displayed on mobile device 112, laptop computing device 114 or desktop computing device 115. Many components of chatbot system 108 have been omitted to avoid unnecessarily complicating the description of the invention. One skilled in the art will realize that chatbot system 108 may comprise more or less components as needed to implement the present invention.

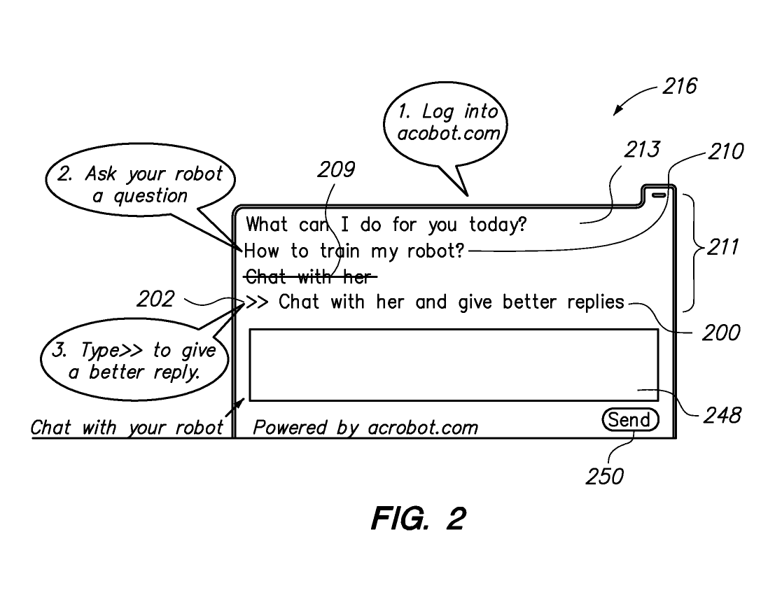

User-generated messages provide a context for subsequent chatbot messages of chatbot system 108, and for subsequent user input messages. In this manner, a new chatbot message is repetitively modified both prior to and during a chat session by entering a plurality of user-generated messages and training chatbot system 108 by preceding and/or following user-generated messages with unique identifiers (e.g., 202 of FIG. 2).

Briefly, in operation, merchant 106 trains chatbot system 108 to provide modified chatbot messages that are displayed by output display 109 of chatbot dialog interface 116. Merchant 106 utilizes merchant website 107 to install and utilize chatbot system 108. Merchant website 107 can provide a plethora of information to numerous customers simultaneously. Merchant website 107 operatively couples to Internet 101 via local network line 128.

Merchant 106 trains chatbot system 108 to provide modified chatbot messages 109 during a chat session. Thus, for example, merchant 106 might wish to teach chatbot system 108 to respond to address inquiries received from users of merchant website 107. User/merchant 106 begins by entering “Where are your offices?” into chatbot dialog interface 116.

In response, chatbot system 108 might generate a response such as “Please check our website, thank you.” Merchant 106 being dissatisfied with this message may wish to replace this chatbot response with the merchant's business address. Generally, merchant 106 can then enter “100 Main Street” into chatbot dialog interface 116. Thereafter, when the customer enters an input message “Where is your business located?,” chatbot system 108 replies, “100 Main Street”. Those skilled in the art will recognize that user-generated message (provided by merchant 106) is more robust and descriptive than the initial chatbot message.

FIG. 2 illustrates chatbot dialog interface 216 of chatbot system 108 (FIG. 1) in accordance with an exemplary embodiment of the present invention.

In FIG. 2, chatbot dialog interface 216 includes a visual graphic that encompasses two main areas namely dialog box 248 and output display 211. User input messages entered via dialog box 248 are displayed in output display 211. Chatbot response messages generated by chatbot system 108 are also displayed by output display 211.

Once chatbot system 108 is initialized, chatbot dialog interface 216 is displayed and is ready to initiate a chat session. Specifically, upon initiation, chatbot system 108 displays a prompt message “What can I do for you today?” 213 that prompts merchant 106 for an input message. “What can I do for you today?” 213 is a special output message, called an initial or opening message.

Responsive to prompt message “What can I do for you today?” 213, the user (e.g. merchant 106) enters an input message “How to train my robot?” 210 into dialog box 248 and then clicks send button 250. Chatbot system 108 responds by displaying output message “Chat with her” 209. Here, merchant 106 is dissatisfied with this message and wishes to train chatbot system 108 to display a modified message from the user.

Merchant 106 then enters user-generated message “Chat with her and give better replies” 200 into dialog box 248. This user-generated message 200 is preceded by a predetermined unique identifier such as the double angle brackets “>>” 202. Alternatively or in addition, the user-generated message 200 may be followed by the predetermined unique identifier. Those skilled in the art will realize that other identifier types e.g., asterisk, etc. can by utilized consistent with the spirit and scope of the present invention.

Predetermined unique identifier 202 directs chatbot system 108 to replace output message “Chat with her” 209 with user-generated message “Chat with her and give better replies” 200. As directed, chatbot system 108 responds to the predetermined unique identifier 202 and replaces output message “Chat with her” 209 with user-generated message “Chat with her and give better replies” 200 and then displays a crossed-out output message “Chat with her” 209 in output display 211 to indicate that message 209 is no longer valid.

Future input inquiries relating to “How to train my robot?” entered into dialog box 248 would generate the response “Chat with her and give better replies”. In this manner, merchant 106 can train chatbot system 108 to provide enhanced responses to input messages from user 102 or other customers. The back and forth interaction between chatbot system 108 and merchant 106 via chatbot dialog interface 216 allows knowledge database 150 (FIG. 1) to be modified based on myriad combinations of user-generated messages 200 as context for additional future chatbot messages.

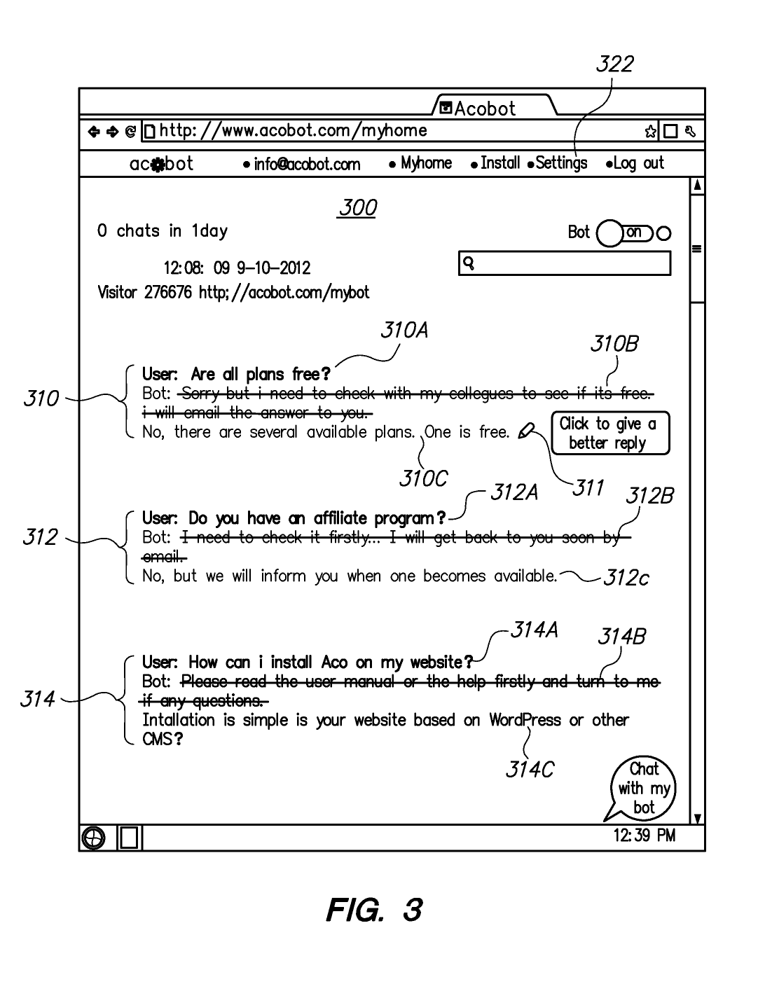

FIG. 3 illustrates chat log 300 according to an exemplary embodiment of the present invention.

In FIG. 3, chat log 300 displays input/output messages 310, 312, 314 communicated between a user and chatbot system 108 during a chat session. An advantage of the present invention is that chat log 300 can be employed to edit input/output messages 310, 312, 314 and consequently corresponding knowledge entries. Specifically, chat log 300 can use scripts to create or update input/output messages 310, 312, 314 that modify knowledge entries for chatbot system 108. As further discussed below, scripts are text files or database records including dialogue and instructions for chatbot system 108. A script typically consists of user messages responsive to the chatbot messages and chatbot messages responsive to the user messages.

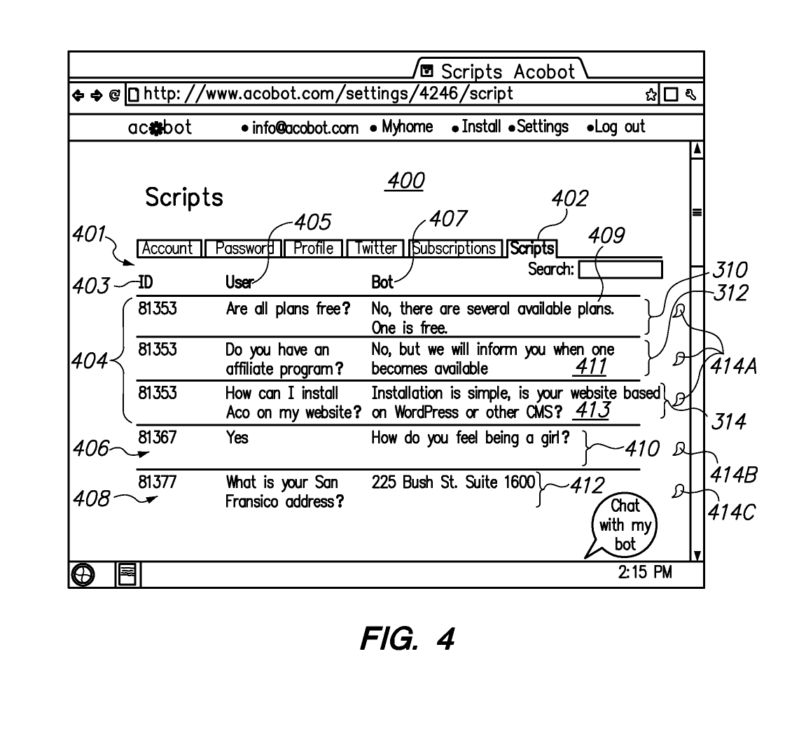

An advantage of the present invention is that the scripts can store and display context information and relationship between the input and output messages in a compact yet intuitive manner; users can easily and efficiently use scripts to update a message without updating other messages that use the updated message as context. An embodiment of the present invention establishes a direct relationship between the input/output messages and consequently the input/output messages and their context as further discussed with reference to FIG. 4. In one embodiment, the scripts are not a “knowledge base” that the chatbot engine can use directly. They are media that bridge front end (all training features) and the back end (the chatbot engine).

Referring now to FIG. 3, input/output messages 310, 312, 314 are entered during a chat session. Specifically, a user such as merchant 106 (FIG. 1) uses dialog box 248 (FIG. 2) to enter the input/output messages during the chat session. Here, the initial user input message is “Are all plans free?” 310A. Responsive thereof, chatbot system 108 responds with output message “Sorry, but I need to check with my colleagues to see if it is free. I will email the answer to you.” 310B. This output message 310 is crossed out and replaced with user-generated output message “No, there are several available plans. One is free.” 310C.

The same goes for input/output message 312. A follow up input message “Do you have an affiliate program?” 312A is entered into chatbot system 108. The responsive output message “I need to check it first. I will get back to you soon by email.” 312B is crossed out. And, it is replaced with user-generated output message “No, but we will inform you when one becomes available.” 312C.

As for input/output message 314, the follow up inquiry is “How can I install Aco on my website?” 314A. The chatbot output message is “Please read the user manual or online help first, and contact me if any question.” 314B. This output message 314B is crossed out and replaced with a new user-generated output message “Installation is simple. Is your website based on WordPress or other CMS?” 314C.

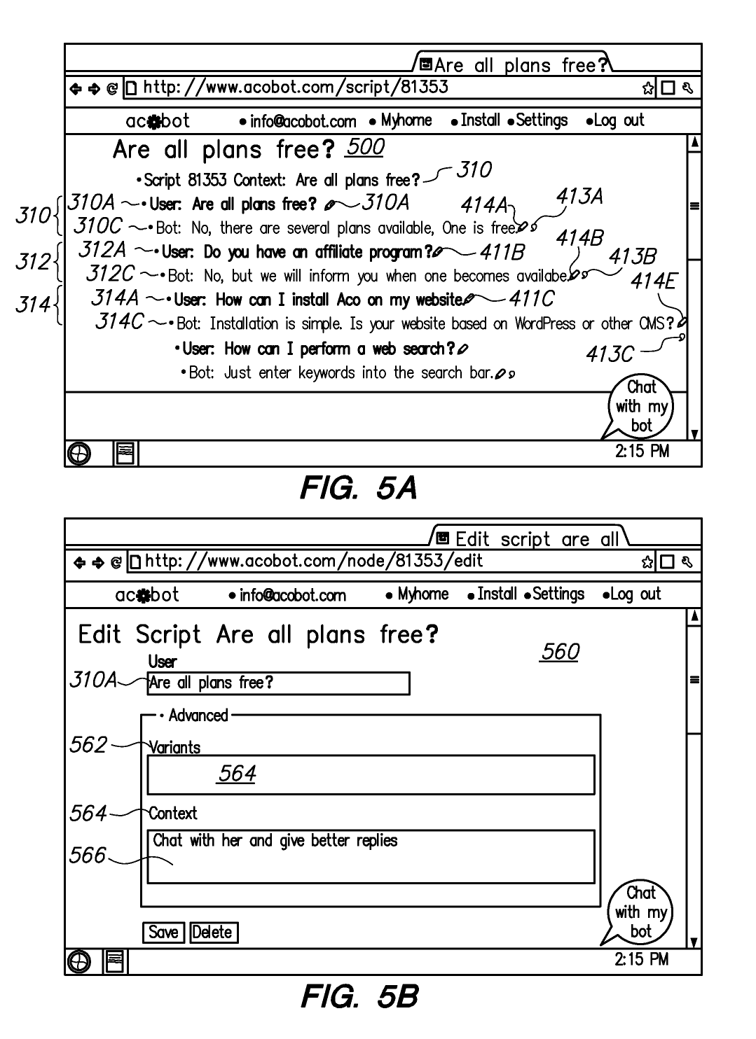

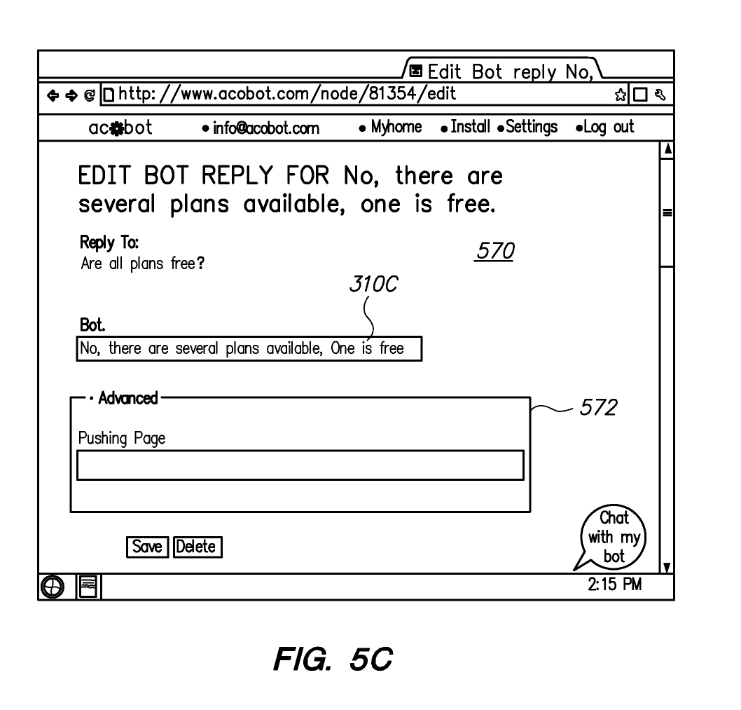

Note here that output message “Installation is simple. Is your website based on WordPress or other CMS?” 314C is a question that requires a response from a user. The response, “Yes” or “No” need not be entered and stored during the chat session via dialog box 248. Unlike conventional systems and methods, such input/output messages can be intuitively added and edited via a script user interface described with reference to FIGS. 4 and 5.

Chat Log Training Via Scripts

Where users find an unsatisfying reply such as output message 310B given by the chatbot system 108 when reviewing the chat logs, users can select the unsatisfying reply, and select enter a better reply. Chatbot system 108 marks the old reply as deleted and also displays a new reply.

Chatbot system 108 checks if the old reply is provided by a script; if yes, chatbot system 108 updates the corresponding output message node; if not, chatbot system 108 creates a new script with the user message and the better reply as its child. Thus, in one embodiment, the present invention can automatically create scripts allowing the user to modify input/output messages with context. In an alternate embodiment, the present invention allows users to manually create scripts with input/output messages with context.

Creation of New Scripts

Upon reviewing the chat log, a user can provide a better reply by using chatbot system 108 to create a new script or update an existing one. First, chatbot system 108 checks if the context (“Bot message 1”) matches any of the existing Bot replies (field_message in Bot reply nodes or field_context in Script node). If NO, chatbot system 108 creates a new Script node with field_message=“User message 1” & field_context=“Bot message 1.” The user can then enter a new Bot reply. If the context matches any of the existing Bot replies, chatbot system 108 lists all user replies with the matched context and allows the user to select one that means the same. When the user selects a desired user reply, chatbot system 108 adds the selected user reply as a new variant of the existing user reply.

Chatbot system 108 then checks if a Bot reply exists for the above User reply. If YES, the process ends. If NO, the user is allowed to enter a new Bot reply. If the client selects NONE, chatbot system 108 checks if the matched context includes any Bot reply. If YES, chatbot system 108 adds the User reply as a child of the Bot reply with fewer replies. And then the user is allowed to enter a Bot reply. If NO, chatbot system 108 adds a new Script node and the user enters a Bot reply.

Note that if chatbot system 108 finds one Bot reply as matched context, it adds the new User reply as its child. If chatbot system 108 finds two or more Bot replies as matched context, it chooses one of the two as the parent of the new User reply. Typically, it chooses one with least children (User replies following it). An example of a script is as follows:

$$…$$

$$Bot \text{:} Bot message 1$$

$$User \text{:} User message 1$$

$$…$$

$$Bot \text{:} Bot message 1$$

Note that if “Bot message 1” is the matched context, one of them is chosen as the parent of the new User reply. In the above example, the second “Bot message 1” has no child so new User reply is added to it. Note also that the interactions above are applied only when the system automatically creates new scripts.

Variants

During a chat session, users typically use different sentences to express the same meaning. Because the sentences have the same meaning, an embodiment of the present invention generates a single output responsive all of the sentences. Traditionally, users had to list all of the sentences and repeat the same answer to each sentence. Thus, the traditional process is inefficient and also makes it difficult to maintain the knowledge base.

Users also had to define a first sentence having the same meaning as a second sentence, and then provide an output message for the second sentence. This process often causes loops as users cannot remember which of the first or second sentence has the output message.

An embodiment of the present invention overcomes problems associated with conventional systems by using a “Variants” field to the user reply message (user input message) node. With this Variant field, users can add different sentences with the same meaning to the user message as needed. Consequently, this feature improves efficiency and productivity as all of the different sentences are maintained in a single location. With the Variants field, users can easily work with all input messages that share a response as all sentences are in a single location.

Script to AIML Categories Process

When users create any scripts, the system generates an AIML category for each pair of input/output defined in the script. In AMIL, context is represented with THAT element. First, dependents or a list of patterns that cannot convey accurate meaning without context are prepared. For example, Yes, No, What does it cost? For each AIML category, its Pattern is normalized input message, its Template is exactly same as the output message. When generating each category, the system checks if the category with the same pattern exists. If no, the system checks if the pattern is a dependent. If yes, the system generates a category with Pattern and Template with Context. If no, the system generates a category with Pattern and Template without Context. If yes, system generates a category with Pattern, Template, and Context, which is the normalized previous output message, which can be obtained through the context ID. When users edit/delete the scripts, the system updates the categories accordingly. Where the input message is modified or any message is deleted, the system checks whether the context definitions for other categories are need to update. A simple solution is to regenerate all categories to ensure the integrity.

FIG. 4 illustrates scripts interface 400 according to an exemplary embodiment of the present invention.

In FIG. 4, scripts interface 400 provides access to all stored scripts 404, 406, and 408 having input/output messages therein. Once accessed, scripts display input/output messages contained therein in a tree format having a parent/child relationship structure. Note here that scripts interface 400 is itself accessed by first selecting setting link 322 of FIG. 3 and then selecting tab 402.

Referring now to FIG. 4, scripts interface 400 shows all of the available scripts 404, 406, 408 within table 401. This table format enables quick and convenient access to the scripts.

The first column of table 401 is ID 403, which shows identifier numbers (thus context) associated with each script. This unique identifier identifies the context for the script. The identifier can be numeric, for example, or can also be alphanumeric as well. One skilled in the art will understand that different types of unique identifiers may be utilized.

The second column is User 405 which shows the user input message. The third column is labeled Bot 407, which shows the chatbot output message corresponding to the user input message. Table 401 also shows view thread icons 414A, 414B, and 414C. When a view thread icon is selected, the associated script is displayed in a table format as shown in FIG. 5A.

In FIG. 4, script 404 stores input/output messages 310, 312 and 314 discussed in FIG. 3. As input/output messages 310, 312, 314 are entered, they are each assigned identifiers. First, in one embodiment relating to manual creation of scripts, script 404 is created when user input message “Are all plans free?” 310A is entered by a user. Chatbot system 108 stores it as a database record, with the unique identifier 81353. Next, “No, there are several available plans. One is free” 409 is entered, assigned a unique identifier, not shown, and saved as a child of “Are all plans free? 310A, etc. This scheme is continued for input/output messages 312 and 314.

Input/output message 310 is shown in row 409 of table 401. Input/output message 312 is shown in row 411 with the same script identifier as input/output message 310, with the user input message “Do you have an affiliate program?” and Bot output response of “No, but we will inform you when one becomes available.”

Input/output message 314 is shown in row 413, same script ID as input/output messages 310 and 312, and user input message is “How can I install Aco on my website?” with Bot output message “Installation is simple. Is your website based on WordPress or other CMS?” In this manner, users can quickly see at a glance which knowledge entry pairs are associated with each script file. Users can then determine which scripts to modify, edit or add to by selecting view thread icons 414A, 414B or 414C.

Note here that script interface 400 also shows script 406 and script 408 with different script ID 403 numbers. These different ID numbers indicate that the scripts have different contexts. Similarly, script 408 includes input/output message 412 as shown. In one embodiment, this script, which has a different context, might be created manually by a user or automatically by chatbot system 108. In this manner, embodiments of the present invention can enable determination of which input/output messages have the same context and for the input/output messages to be stored together if they have the same context.

In operation, a user such as merchant 106 begins by selecting settings link 322 of FIG. 3 to display scripts interface 400. Thereafter, scripts 404, 406 and 408 become selectable via view thread 414A, 414B or 414C to display the desired script file for further editing.

FIG. 5A illustrates script interface “Are all plans free?” 500 in accordance with an exemplary embodiment of the present invention.

In FIG. 5A, script interface “Are all plans free?” 500 displays script 404 (FIG. 4) and its stored input/output messages 310, 312, 314 and first context “Are all plans free?” 310 in a tree format. Unlike conventional systems, the present invention displays input/output messages and their context in a tree format that can be viewed by users in an intuitive manner and enables users to easily modify entries. Input/output messages are modifiable using this script, and when a message is modified, there is no need to update other entries that use the modified message as context.

In FIG. 5A, script interface “Are all plans free?” 500 can be accessed by selecting view thread icon 414A in FIG. 4. Upon selection, the input/output messages 310, 312 and 314 are displayed in a tree format. Note that this script can be manually created by a user or can be automatically generated by the system using a “better reply” link 311 of chat log 300 of FIG. 3.

As seen, the script identifier is 81353 along with first context “Are all plans free?” 310A as shown. As used herein, context refers to a previous input or output message or knowledge entry that gives meaning to a current input or output message or knowledge entry. For example, in the following chat session: the context for the user input message “Yes,” is “Are you a girl?”
User: Are you a female bot?
Bot: Yes. Are you a girl?
User: Yes
Bot: How do you feel being a girl?

In FIG. 5A, “Are all plans free?” 310A is the first context in a dialogue sequence between the user and chatbot system 108. Script 404 is assigned to this context using the identifier 81353. As can be seen, all of the input/output messages are then displayed in a tree format for easy viewing by the user. This tree format is shown in FIG. 5A.

Input message 310A is first shown as a parent or root entry, which is the first entry that has no other references. Next, output message 310C is a child of input message 310A and is shown indented below input message 310A. The user enters this output message and the system saves it as a database record with the following additional data: the unique identifier (not shown) of output message 310C and the parent identifier (81353) of the input it replies to namely input message 310A.

Next, input message 312A is a child of output message 310C and is subsequently indented below output message 310C. The user enters input message 312A and the systems creates a database record with the following additional data: the unique identifier of input message 312A, the parent identifier of output message 310C, which input message 312A is replying to, and the context identifier of the previous output message 310C.

This process is repeated for subsequent messages, with unique identifiers being assigned for the current message, a parent identifier and a context identifier. Thus, in FIG. 5A, output message 312C is a child of input message 312A. Input message 314A is a child of output message 312C, and finally, output message 314C is a child of input message 314A. Therefore, all subsequent input/output messages under “Are all plans free? 310 are displayed in a tree format based on identifier 403.

Users can enter input/output messages as desired. As the context information and relationship between the messages are kept and displayed in a compact yet intuitive manner, users can easily and efficient work with the scripts, without worrying about the inconsistency. When users want to add a new input when there is no existing output message, they create another new script. When users delete an input or output message from the script, system deletes all of its children and children of children, or asks users whether they want to move the children as the new children of other messages or to a new script.

The subsequent input/output messages 312, 314 are displayed as children of input/output message 310. Thus, chatbot system 108 displays input/output messages in an intuitive manner where child entries that use parent entries as context can easily be seen, thus establishing a direct relationship between the child entries and parent entries.

As further illustration, consider the following chat session between a user and chatbot system 108 (Chatbot).
User (Message 1): Are you a female bot?
Chatbot (Message 2, a child of Message 1): Yes. Are you a girl?
User (Message 3, a child of Message 2): Yes.
Chatbot (Message 4, a child of Message 3): How do you feel being a girl?

An embodiment of the present invention provides a structure that contains all information that the traditional structure contains. A traditional structure, as discussed previously in the background of the present application, would contain two separate entries. Unlike such traditional systems, one embodiment is a single tree format; however, this tree format can generate two input/output messages in traditional format. This single tree format also contains additional information that the traditional method does not.

Unlike a traditional system that uses two entries, the message “Are you a girl?” appears only once in the above data structure. It serves as the reply to the previous user message and the context for the next user message. Thus, when a user such as merchant 106 or an administrator edits this message, the reply and context are updated at the same time, and thus, consistency is maintained. For example, where “girl” is updated as “female, it looks like:
User (Message 1): Are you a female bot?
Chatbot (Message 2, a child of Message 1): Yes. Are you a female?
User (Message 3, a child of Message 2): Yes.
Chatbot (Message 4, a child of Message 3): How do you feel being a girl?

Unlike traditional systems, the chatbot system 108 responds without any problem. The benefits of the present invention can be seen with the following additional examples: In the above example, the user would answer either “Yes” or “No” to the question posed by chatbot system 108. Chatbot input/output messages replying to either question respectively are entered. In traditional systems, the knowledge entry looks like:
Entry 1
User: Are you a female bot?
Chatbot: Yes. Are you a female?
Entry 2
User: Yes
Context: Are you a girl?
Chatbot: How do you feel being a girl?
Entry 3
User: No
Context: Are you a girl?
Chatbot: How do you feel being a boy?

As the number of entries grows, it gets more and more difficult for an administrator to understand and maintain the knowledge base. An embodiment of the present invention, on the other hand, generates the following tree format with child nodes indented. An administrator can easily work with the knowledge data even where there are many branches in the dialog.
User (message 1): Are you a female bot?
Chatbot (message 2, child of message 1): Yes. Are you a female?
   User (message 3, child of message 2): Yes.
   Chatbot (message 4, child of message 3): How do you feel being a girl?
   User (message 5, child of message 2): No.
   Chatbot (message 6, child of message 5): How do you feel being a boy?

Referring now to FIG. 5A, each input message of input/output messages 310, 312 and 314 has a corresponding edit icon for making edits to that input message. Thus, input message 310A has adjacent edit icon 411A. When selected, edit icon 411A displays script interface “Edit Script: Are all plans free?” 560 of FIG. 5B for editing input message 310A.

FIG. 5B illustrates script interface “Edit Script Are all plans free?” 560 according to an exemplary embodiment of the present invention.

As shown in FIG. 5B, script interface “Edit script: Are all plans free?” 560 provides advanced settings for variants 562 for entering different expressions of input message 310A in text box 564. As shown, context 564 of input message 310A can be changed by entering a new context in text box 566. Unlike conventional systems, the present invention provides advanced functionality providing a rich experience and simplicity in editing and replying to messages.

Referring now to FIG. 5A, similarly, input message 312A has edit icon 411B for making edits to an input message, and input message 314A includes edit icon 411C for making edits to input message 314A. Although not shown, selection of edit icons 411B or 411C will provide advanced functionalities similar to edit icon 411A.

In FIG. 5A, each output message also has a corresponding edit icon and reply icon. Thus, output message 310C includes edit icon 414A that can be used to edit output message 310C. When edit icon 414A is selected, script interface “Edit bot reply: There are several available plans. One is free” 570 of FIG. 5C is shown.

FIG. 5C illustrates a script interface “EDIT BOT REPLY: THERE ARE SEVERAL AVAILABLE PLANS. ONE IS FREE” 570 according to an exemplary embodiment of the present invention.

In FIG. 5C, merchant 106 can use script interface 570 to edit output message 310C. A user can also specify pushing page 572, the full URL to webpage that is loaded when output message 310C is generated. Thus, the specified webpage can be loaded into a user's or customer's browser without requiring further selection of links by the user. This advantage is further detailed in a related patent application currently co-pending with the present application.

Referring now to FIG. 5A, reply icon 413A is also displayed adjacent to output message 310C. When reply icon 413A is selected, a script interface (not shown) that allows a user reply script to output message 310C to be created is displayed. Variants to the user reply can also be included in the user reply script. In the same manner, output message 312C has an adjacent edit icon 414B for editing output message 312 C and reply icon 413B for creating a user reply to output message 312C. Similarly, output message 314C has an adjacent edit icon 414E for editing output message 314C and reply icon 413C for creating a user reply to output message 314C.

In FIG. 5A, a further advantage of the present invention is that branches of input/output messages can be created and administered with relative ease. Thus, noted in FIG. 3, output message “Installation is simple. Is your website based on WordPress or other CMS?” 314C is a question that requires a response from a user.

The user responses “Yes” and “No” need not be entered and stored during the chat session via dialog box 248 (FIG. 2). Rather, appropriate branch responses can be manually created by selecting reply icon 413C.

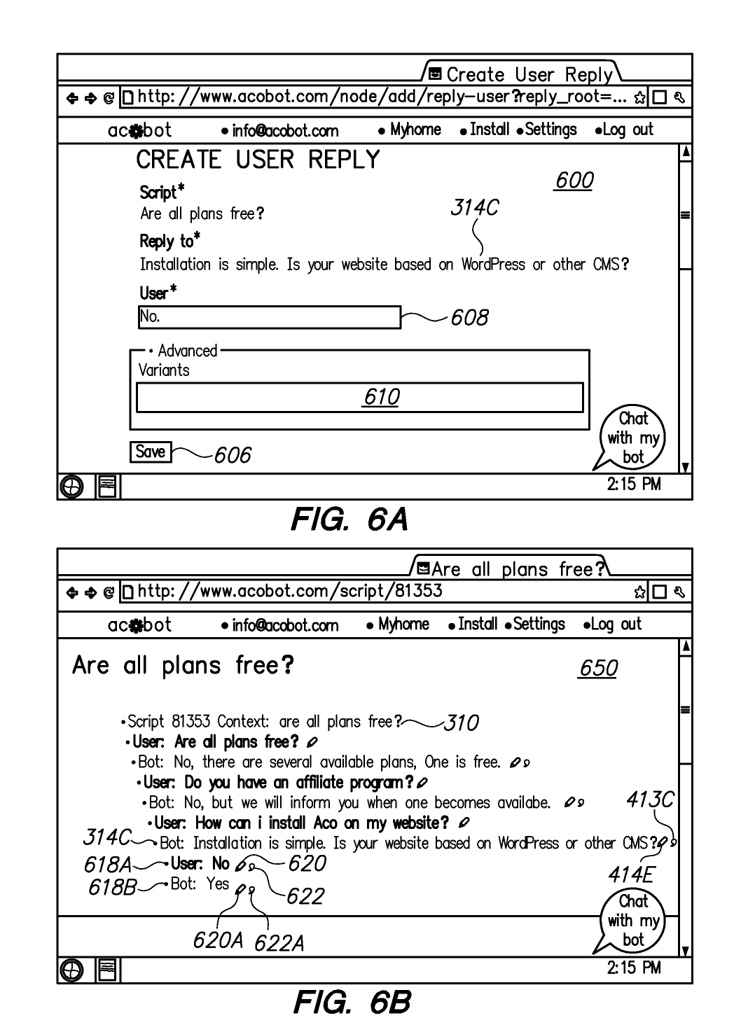

To create the user input message “No” response, reply icon 413C is selected. Upon selection, script interface “Create user reply” 600 of FIG. 6A.

FIG. 6A illustrates a script interface “CREATE USER REPLY” 600 according to an exemplary embodiment of the present invention.

In FIG. 6A, “Create user reply” interface 600 includes text box 608. Here, the word “No” is entered in text box 608 to respond that the website is not based on WordPress or other CMSs. The user then selects save button 606 to save the reply. Variants of the word “No” can also be entered in text box 610. To create the user input “Yes” response, reply icon 413C is also selected and the word “Yes” (not shown) is entered in text box 610. After creating the “No” and “Yes” replies, the input/output messages are displayed as shown in FIG. 6B.

FIG. 6B illustrates script interface “Are all plans free?” 650 according to an exemplary embodiment of the present invention.

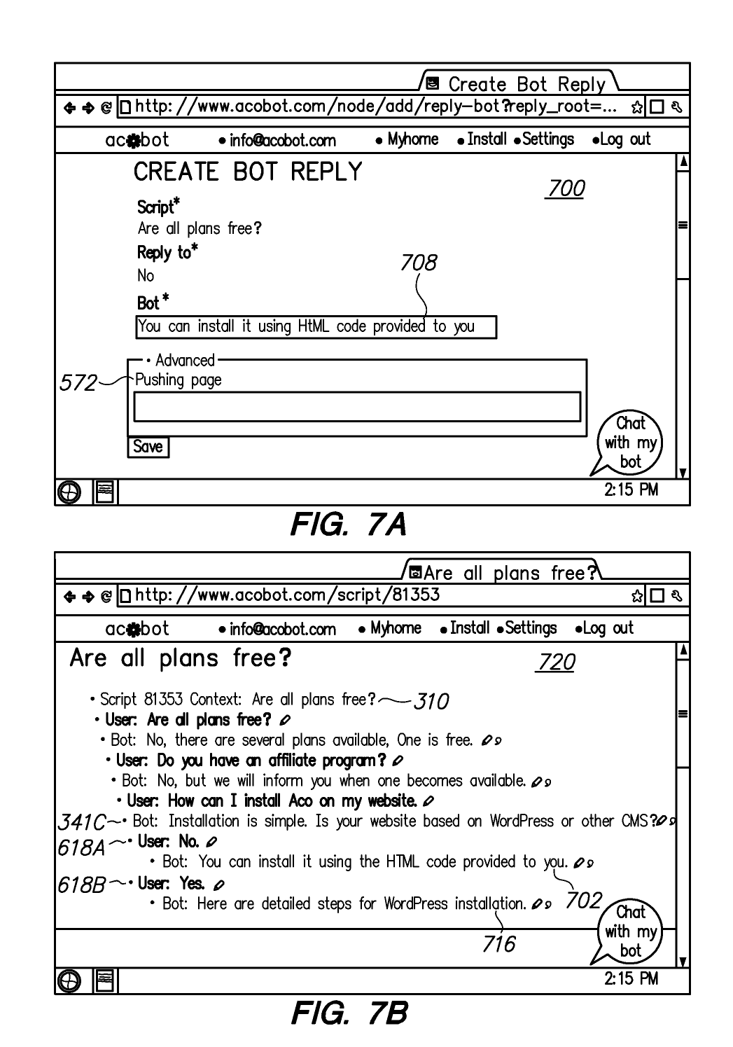

In FIG. 6B, script interface “Are all plans free?” 650 shows user input “No” 618A and user input message “Yes” 618B of FIG. 6A. Edit icon 620 can be used to edit input message 618A. Similarly, edit icon 620A can be used to edit input message 618B. Reply icon 622A can create a chatbot reply to input message 618B. Reply icon 622, when selected, displays script interface “CREATE BOT REPLY” 700 of FIG. 7A.

FIG. 7A illustrates a script interface “CREATE BOT REPLY” 700 according to an exemplary embodiment of the present invention.

In FIG. 7A, script interface “CREATE BOT REPLY” 700 includes text box 708 for entering the chatbot reply output message “You can install it using HTML code provided to you” as shown. Reply icon 622A (FIG. 6B) can create a chatbot reply to input message 618B (FIG. 6B) except that that chatbot reply is “Here are the detailed steps for WordPress installation.”

FIG. 7B illustrates script interface “Are all plans free?” 720 according to an exemplary embodiment of the present invention.

In FIG. 7B, script interface “Are all plans free?” 720 shows chatbot reply output message “You can install it using HTML code provided to you.” 702 responsive to input message 618A and chatbot output message “Here are detailed steps for WordPress installation.” 716 responsive to user input message 618B.

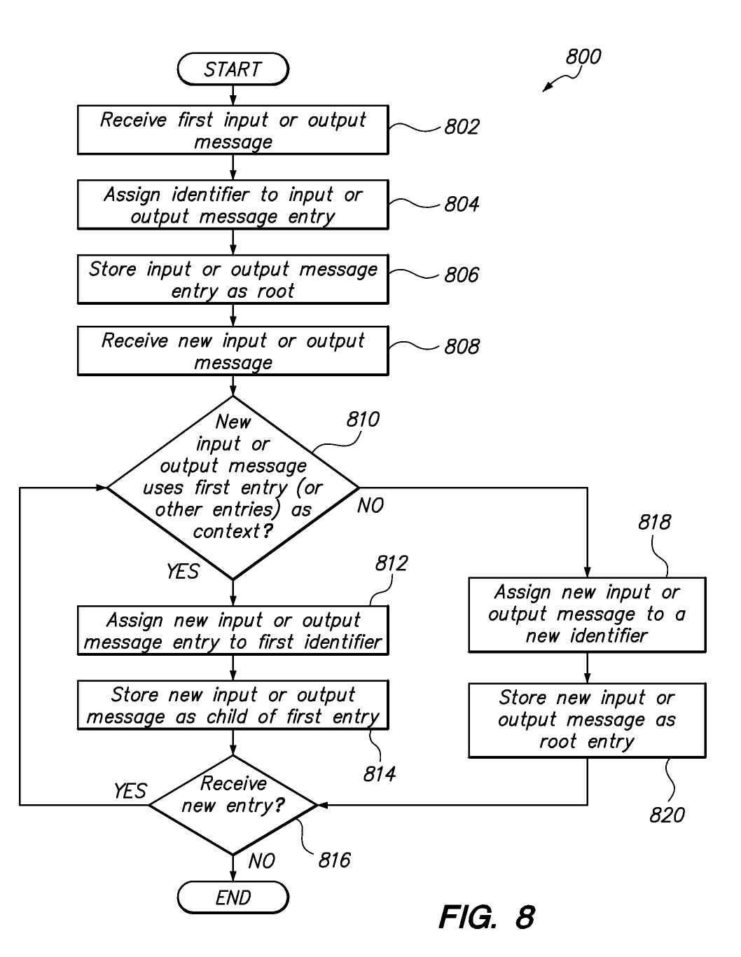

FIG. 8 is a flow chart illustrating method 800 according to an exemplary embodiment of the present invention.

In FIG. 8, method 800 can be operated by chatbot system 108 (FIG. 1) to store and display input/output messages and their context based on a manually created script.

At block 802, a first input or output message is received by chatbot system 108. The first input or output message might be entered via a “create new script” link available on a chatbot system 108 website for example. Thereafter, execution proceeds to block 804.

At block 804, a unique identifier is assigned to the first input or output message. Preferably, the identifier is a numeric one although other type identifiers, such as an alphanumeric one, might be employed. After the unique identifier is assigned, execution proceeds to block 806.

At block 806, the first input or output message is stored as a root entry. The root entry is a first or parent entry in a tree format structure.

At block 808, a new input or output message is received following the first input or output message.

At decision block 810, it is determined whether the new input or output message uses the first input or output message as context. If so, execution proceeds to block 812, else execution proceeds to block 818.

At block 812, it has been determined that the new input or output message uses the first input or output message as context. Consequently, the new input or output message is assigned a unique identifier, while the identifier of its parent is stored as well.

At block 814, the new input or output message is stored as a child of the first input or output message. Based on the reference knowledge entry, the entire tree format including parent and children can be easily displayed.

For subsequent input or output messages that use the preceding input as context, those subsequent inputs are stored as children. The system creates a database record with a unique identifier for the subsequent message, a parent identifier and a context identifier of the previous message. This process is repeated for subsequent messages.

In this manner, a direct relationship is established between the new input or output message and the preceding message. In traditional systems, the input/output text is stored as the context information. Unlike such traditional systems, an embodiment of the present invention stores the pointer or reference (e.g., identifier) to the previous input or output message used as context. In this manner, if the context information can be changed without having to change data for all of the subsequent entries.

At decision block 816, if a new input or output message is received, execution proceeds back to decision block 810 where the new entry is processed as described above. Else, method 800 is terminated.

At block 818, it has been determined that the new input or output message does not use the first input or output message or existing input/output messages as context. Thus, a new script is created, and a new identifier is assigned to the new input or output message.

At block 820, the new input or output message is stored as a new root entry. Once the system is set up, users can add an unlimited number of input/output messages. If a new entry uses any existing entry as context, users add it as a child of the existing entries. If the new entry does not have a context or its context does not match any existing entry, users add it as a new root entry.

Thus, as can be seen, an embodiment of the present invention intuitively displays input/output messages and their context in a tree format so that a need does not exist to modify other input/output messages. A direct relationship is established between input/output messages and their context. An embodiment of the present invention stores a first input or output message as reference to other entries with the same context, establishing a direct relationship between an entry and its context. Based on this reference, input/output messages are displayed along with the entries that provide their context. In one embodiment, once chatbot system 108 is initiated, users such as merchant 106 can add input/output messages to the system by first adding a root entry. Typically, the root entry is the first reference as there are no other input/output messages. Users then add the input/output messages that use the first entry as context.

In one embodiment, chatbot system 108 of the present invention then stores the reference to the first input or output message along with the new input/output messages. A user can continue to add any number of input/output messages. When a new knowledge entry uses an existing entry as its context, a user can add the new knowledge entry as a child of the existing entry. If the new knowledge entry has no context, the user can add it as a new root entry. Note that the present invention does not store the input/output data as context, but rather it stores the reference identifier of the context along with the input/output for any new entry.

Alternatively, users can provide context manually; chatbot system 108 can check whether there is a match between any existing input/output messages. If “Yes,” the new entry is added as a child of that entry. Where there are multiple entries that match the given context, chatbot system 108 can either choose the first matched entry for simplicity or prompt users to select one of the displayed context. If a root entry does not match any other existing context, the user can manually enter a context for that root entry. In this manner, the root entries can have context as well. Where a tree contains a large number of input/output messages and it is not convenient to view all entries on the output device at a time, chatbot system 108 can display a limited number of entries. Users can then navigate and select different parts of the tree.

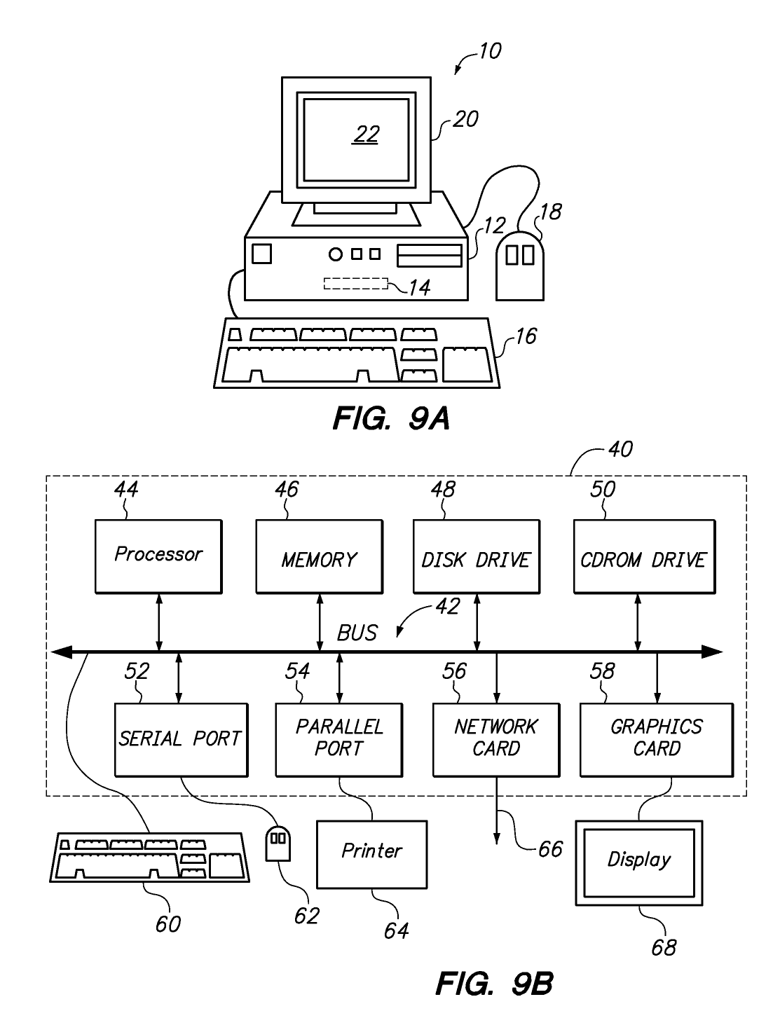

FIG. 9A shows a typical computer 10 such as would be operated by a user on the Internet and suitably programmed using one or more lines of code to execute embodiments of the present invention. Computer 10 includes a cabinet 12 housing familiar computer components such as a processor, memory, disk drive, Compact Digital Read-Only Memory (CDROM), etc. (not shown). User input devices include keyboard 16 and mouse 18. Output devices include display 20 having a display screen 22. Naturally, many other configurations of a computer system are possible. Some computer systems may other components in addition to those shown in FIG. 9A while others will have fewer components. For example, server computers need not have attached input and output devices since they may only be accessed from time to time by other computers over a network. Human interaction with such a server computer can be at another computer that is equipped with input and output devices. Input and output devices exist in many variations from those shown in FIG. 9A. Displays can be liquid crystal displays (LCD), computer monitors, plasma, etc. Input devices can include a trackball, digitizing tablet, microphone, etc. In general, use of the term “input device” is intended to include all possible types of devices and ways to input information into a computer system or onto a network. Likewise the term “output device” includes all possible types of devices and ways to output information from a computer system to a human or to another machine.

The computer itself can be of varying types including laptop, notebook, palm-top, pen-top, etc. The computer may not resemble the computer of FIG. 9A as in the case where a processor is embedded into another device or appliance such as an automobile or a cellular telephone. Because of the ever-changing nature of computers and networks, the description of hardware in this specification is intended only by way of example for the purpose of illustrating the preferred embodiment. Any distributed networked system capable of executing programmed instructions is suitable for use with the present invention.

FIG. 9B shows subsystems of the computer of FIG. 9A. In FIG. 9B, subsystems within box 40 are internal to, for example, the cabinet 12 of FIG. 9A. Bus 42 is used to transfer information in the form of digital data between processor 44, memory 46, disk drive 48, CDROM drive 50, serial port 52, parallel port 54, network card 56 and graphics card 58. Many other subsystems may be included in an arbitrary computer system, and some of the subsystems shown in FIG. 9B may be omitted. External devices can connect to the computer system's bus (or another bus or line, not shown) to exchange information with the subsystems in box 40. For example, devices such as keyboard 60 can communicate with processor 44 via dedicated ports and drivers (shown symbolically as a direct connection to bus 42). Mouse 62 is connected to serial port 52. Devices such as printer 64 can connect through parallel port 54. Network card 56 can connect the computer system to a network. Display 68 is updated via graphics card 58. Again, many configurations of subsystems and external devices are possible.

While the above is a complete description of exemplary specific embodiments of the invention, additional embodiments are also possible. As an example, embodiments of the present invention create one node for an input message and another node for an output message. In an alternative embodiment, a single node for a pair of input message and output message can be utilized. Thus, the above description should not be taken as limiting the scope of the invention, which is defined by the appended claims along with their full scope of equivalents.

I claim:

1. A method, operable by a chatbot, for adding and representing contextual input or output messages to modify knowledge entries, wherein the chatbot includes a processor, an interactive dialog interface and a knowledge database, the method comprising:
storing a first input message as a root entry, wherein said root entry represents a first entry or parent in a tree format;
using the first input message as context for subsequent input/output messages by
(1) assigning an identifier to the first input;
(2) associating subsequent input/output messages with the identifier; and
(3) storing the subsequent input/output messages as child entries of the first input, said child entries representing children of the parent in the tree structure.

2. The method of claim 1 further comprising
using a script to displaying the first and subsequent input/output messages in the tree format.

3. A method by a user interface executing on a processing platform including a processor coupled to a user input device, display and memory, said method displaying input and output messages for a chat session between a user and a chatbot, said method comprising:
using a script to display a plurality of input and output messages in a tree format by displaying a first input or output message as a root entry, wherein said root entry represents a first entry or parent in a tree format;
displaying a script identifier assigned to first input or output message, the script identifier being used to identify the first input or output message as context for at least one of one or more of subsequent input/output messages;
displaying a second input or output message as a child entry of the first input or output message; and
displaying a third input or output message as a child entry of the second input or output message so that the user can view a relationship between all of the input and output messages based on the tree format.

4. The method of claim 3 wherein the second input or output message is assigned a second identifier that identifies the second message, and wherein the third input is assigned a third identifier that identifies the third input or output message.

5. The method of claim 4 wherein the second input is stored with the second identifier and the script identifier, and the third identifier is stored with the third identifier, the second identifier and the script identifier.

6. The method of claim 3 further comprising
using the script to displaying an edit link configured upon selection to edit one or more of the input or output messages, and a reply link configured upon selection to reply to one or more of the input or output messages.

7. The method of claim 2 wherein each of the first and subsequent input/output messages is editable by users via the script.

8. The method of claim 1 further comprising
adding a new input or output message as a new root entry where the first input or output message is not context for the new input or output message.

9. The method of claim 8 further comprising
using the new input or output message to establish a direct relationship between the new input or output message and additional input/output messages by
assigning a new identifier to the new input or output message;
associating the additional input/output messages with the new identifier; and
storing the additional input/output messages as child entries of the new input or output message, said child entries representing later entries or children of the parent.

10. A method, operable by a chatbot that includes a processor, an interactive dialog interface and a knowledge database, the method comprising:
storing a first input or output message, wherein said first input or output message can be the chatbot response to a corresponding user input message;
assigning an identifier to said first input or output message; and
using the identifier as context for the subsequent input/output messages by associating and storing the identifier with each of said subsequent input/output messages.

11. The method of claim 10 further comprising
storing the first input or output message as a root entry representing a first entry or parent in a tree format.

12. The method of claim 11 further comprising
storing the subsequent input/output messages as child entries of the first input or output message, said child entries representing later entries or children of the parent in the tree format.

13. The method of claim 12 further comprising
displaying the first and subsequent input/output messages in the tree format.

14. The method of claim 12 wherein each of the first and subsequent input/output messages are editable by users.

15. The method of claim 12 further comprising
adding a new input or output message as a new root entry where the first input or output message is not context for the new input or output message.

16. The method of claim 15 further comprising
using the new input or output message to establish a direct relationship between the new input or output message and additional input/output messages by assigning an identifier to the new input or output message;
associating the additional input/output messages with the new input or output message identifier; and
storing the additional input/output messages as child entries of the new input or output message, said child entries representing later entries or children of the parent.

17. A computer program product including a computer readable storage medium and including computer executable code for a chatbot, the computer executable code being executed by a processor, the computer program product comprising:
one or more code instructions storing a first input or output message, wherein said first input or output message can be the chatbot response to a corresponding user input message;
one or more code instructions assigning an identifier to said first input or output message; and
one or more code instructions using the first input or output message as context for the subsequent input/output messages by associating and storing the identifier with each of said subsequent input/output messages.

18. The computer program product of claim 17 further comprising
one or more code instructions storing the first input or output message as a root entry representing a first entry or parent in a tree format.

19. The computer program product of claim 18 further comprising
one or more code instructions storing the subsequent input/output messages as child entries of the first input or output message, said child entries representing later entries or children of the parent in the tree format.

20. The computer program product of claim 17 further comprising
one or more code instructions displaying the first and subsequent input/output messages in the tree format.

21. The computer program product of claim 17 wherein each of the first and subsequent input/output messages are editable by users.

22. The computer program product of claim 17 further comprising
one or more code instructions adding a new input or output message as a new root entry where the first input or output message is not context for the new input or output message.

23. The method of claim 18 further comprising
one or more code instructions using the new input or output message to establish a direct relationship between the new input or output message and additional input/output messages by
one or more code instructions assigning an identifier to the new input or output message;
one or more code instructions associating the additional input/output messages with the new input or output message identifier; and
one or more code instructions storing the additional input/output messages as child entries of the new input or output message, said child entries representing later entries or children of the parent.

24. The method of claim 2 wherein said script includes a user message node for entering user reply messages to the chatbot, said user message node including a variant field for entering variations of the user reply messages.
